(19) United States
(12) Patent Application Publication
(10) Pub. No.: US 2006/0039408 A1
(43) Pub. Date: Feb. 23, 2006

(54) Budget sensor bus

(75) Inventors: Klaas Wortel, Phoenix, AZ (US); Richard E. Wahler, St. James, NY (US); Andrew W. Lueck, Austin, TX (US)

Correspondence Address: MEYERTONS, HOOD, KIVLIN, KOWERT & GOETZEL, P.C., P.O. BOX 398, AUSTIN, TX, 78767-0398, US

(73) Assignee: Standard Microsystems Corporation

(21) Appl. No.: 10/924,211

(22) Filed: Aug. 23, 2004

(51) Int. Cl. H04J 3/16

(52) U.S. Cl. 370/470

(57) ABSTRACT

A single-wire bus protocol named Budget Sensor Bus (BBUS) for simplified system management. The BBUS may transmit information packets in NRZ format from a monitored device/circuit to a host. In one embodiment, each packet comprises a start sequence, a data type, a device or register number, device data, and a stop sequence. The BBUS may directly transmit raw data bits from the monitored device/circuit to the host and may use the start sequence to communicate to the host the bit frequency that is used by the monitored device/circuit. Following the start sequence the host may get in sync with the monitored device/circuit and may be enabled to directly read the data bits that follow. The BBUS may provide a means for the monitored device/circuit to immediately transfer device information to the host. All functions and operations required to interpret the device information may reside within the host. The BBUS may transmit information packets from the monitored device/circuit to the host, but not from the host to the monitored device/circuit. In one embodiment the BBUS is used for thermal management, where the monitored device/circuit comprises temperature/voltage sensors, the host is an SIO controller, and temperature/voltage data is transmitted from the sensors to the SIO controller.

### BACKGROUND OF THE INVENTION

1. Field of the Invention

This invention relates generally to the field of digital interface design and, more particularly, to bus interface design.

2. Description of the Related Art

Many digital systems, especially those that include high-performance, high-speed circuits, are prone to operational variances due to temperature effects. This presents a need to implement thermal management and control in many of those systems. Devices that monitor temperature and voltage are often included in order to perform the required thermal management/control, and thus maintain the integrity of the system components. Personal computers (PC), signal processors and high-speed graphics adapters, among others, typically benefit from such thermal management circuits. For example, a central processor unit (CPU) that typically “runs hot” as its operating temperature reaches high levels may require a temperature sensor in the PC to insure that it doesn't malfunction or break due to thermal problems. Sensors may be used to monitor a variety of parameters and may be configured at numerous specified locations within a system. Data received and/or recorded by the sensors is typically transmitted to a processing/control unit that analyzes and uses the data in order to determine what if any action is necessary to maintain reliable and stable system operation. Often, when monitoring thermal responses for protecting systems from possible thermal damage, thermal sensor information is directly provided to hardware logic circuits (failsafe circuits) to increase reliability over software solutions.

Thermal management systems often include fans used in controlling the temperature in the operating environment of system components. Typically, personal computers (PCs) are equipped with a CPU fan and one or more case fans. A remote thermal diode may be integrated on the CPU and may be used by a sensor circuit to capture the temperature of the CPU. A thermal sense diode is often integrated within the sensor circuit where it is typically used to capture ambient temperatures. Current implementations of thermal management systems include integrated digital and analog solutions, which typically lack flexibility due to the difficulties encountered with analog signal routing, and stand-alone solutions that provide higher accuracies and route easier, but are generally more expensive.

One typical approach is to use the System Management Bus (SMBus)—first defined by Intel Corporation in 1995—to connect hardware monitors to the host controller. In many present thermal management systems the sensors typically communicate over the two-wire SMBus and rely on a host to program them and to control them. The SMBus generally has a large number of devices connected to it, from simple temperature sensors to complex management chips, even system memory Dual Inline Memory Modules (DIMMs). Furthermore, more and more features have been added in the sensors, such as thermal trip points, programmable data formats for the temperature data, and programmable conversion rates among others. These features generally result in added digital circuits, affecting the physical layout of IC solutions. Typically, a portion of the silicon area of the sensor circuit is consumed by digital circuitry, the remaining portion by analog sensor components. In addition, being coupled to a large number of devices inevitably results in increasing traffic to the SMBus. The increased traffic leads to an increase in the time required to power up the PC (i.e. extended boot time), and to more complex debugging issues. The SMBus is also prone to occasional loss of communication and may therefore not provide sufficient reliability for certain management applications.

Another approach is to integrate the analog functions together into a single chip in order to save costs and to avoid congestion of the SMBus. Integration solutions however typically result in other problems. It is generally difficult and time consuming to route sensitive analog signals to the chip, and the options for placement of the sensor(s) may also become severely limited. Because of the difficulty in routing all the required connections on PC motherboards, much attention has been given to one-wire communication solutions.

A common system component that incorporates a variety of functions and is typically employed in thermal management systems is the Super I/O (SIO) controller. The Super I/O controller is a single chip, which performs many functions that were previously performed by several pieces of hardware, providing the benefits of design standardization and simplification and thus a reduction in cost. A Super I/O chip is typically responsible for controlling the slower-speed peripherals found in a PC. Standard devices that are virtually the same on every PC make it is possible (and easier) to integrate many control functions into a commodity chip instead of having to consider them for each motherboard design. (Serial port control, parallel port control, floppy disk control). In addition, embedded μControllers and chipset components are also occasionally employed as host/controller devices configured to receive system and/or sensor information, and provide system management functions.

One single-wire protocol that may couple to an SIO device uses ratiometric signaling, where the sensor transmits temperature data by accurately controlling the duty cycle (ratio of pulse width and period) of a square wave. That is, the output of the sensor is in effect a Pulse Width Modulated (PWM) digital signal, where data is coded in the duty cycle of the signal. This solution generally requires substantial processing to be performed by the host in order to extract the data from the duty cycle. For example, the SIO device may need to include a multiplier to convert the ratio received to a standard sensor reading. Ratiometric solutions are also susceptible to noise, typically presenting reliability problems.

Another single-wire protocol is the SensorPath bus introduced by National Semiconductor, which was designed specifically to alleviate some of the problems associated with thermal management systems. The SensorPath bus isolates temperature and voltage data onto a dedicated bus that is more optimized to the purpose, enabling both independent and centralized control of the thermal management system. The bus uses a single wire to connect the SIO device and the sensor and provides a digital interface, simplifying board design and easing placement of components. While the SensorPath bus offers a single-wire solution, it employs a substantially complicated protocol, making a seamless configuration of a thermal management system with the SensorPath bus relatively difficult.

Other corresponding issues related to the prior art will become apparent to one skilled in the art after comparing such prior art with embodiments of the present invention as described herein.

### SUMMARY OF THE INVENTION

Various embodiments of the invention comprise a bus and bus protocol (referred to as Budget Sensor Bus, or BBUS) that can provide a low cost, highly reliable, single pin connection to transmit information from any one of many different device types to any one of many different host types. The transmitted information may include system status, configuration or management data such as CPU type and/or ID, memory size or type, docking type or ID, information about the presence of optional components and ambient light or noise levels, temperature measurements and voltage measurements, among others.

In one set of embodiments, the BBUS couples a sensor circuit to a host, where data transmission over the BBUS is regulated according to a BBUS bus protocol. The sensor circuit may include up to eight temperature sensors, each temperature sensor operable to provide temperature data indicative of a corresponding measured temperature, and up to eight voltage sensors, each voltage sensor operable to provide voltage data indicative of a corresponding measured voltage. In one embodiment, the BBUS directly transmits raw data bits from any respective sensor in the sensor circuit to the host, and uses a pre-amble to “teach” the host what bit frequency is used by the respective sensor. After the pre-amble, the host may get in sync and may be enabled to directly read the data bits that follow. The BBUS may provide a means for the sensor to immediately transfer temperature conversions to the host.

In another set of embodiments, the BBUS may be used to transmit system information from any monitored device in the system in place of either voltage or temperature information, such as system configuration or device identification information, which may be used to more effectively manage the system. For example, one or more CPU's may be connected to a system logic device (for example a Southbridge). The one or more CPU's may transmit CPU type, cache size, revision number, thermal limitation, or other management information via the BBUS. Based on the transmitted information the system logic may be operable to set up a single CPU or multiple CPU system for proper operation with proper operating limits.

In one embodiment, the BBUS is a point-to-point dedicated bus allowing the system logic to recognize the type of any connected device, and/or to be informed by that device at system reset. The BBUS may function to help system logic configure system operation both by the presence or absence of a connected device on a specific pin, and by the data transmitted over that pin. All functions and operations required for interpreting temperature/voltage data, and/or system configuration/device identification data may reside within the host. In one embodiment, the BBUS may transmit data from a sensor/monitored device to a host, but not from the host to the sensor/monitored device.

In one set of embodiments the BBUS protocol features three main states: Reset (or Power Down State), Active State, and Inactive State, and transmits packets of information. Packets may be transmitted in NRZ format, and each packet may comprise a start sequence, a data type identifier, a device number or a register number identifier, information data, and a stop sequence. Each sequence and identifier, as well as the information data may comprise a determined number of bits. For example, in one embodiment each packet comprises a three-bit start sequence, one sensor-type bit, a three-bit sensor number, eleven-bit sensor data and one stop bit.

Thus, the BBUS provides a more cost effective thermal sensing and/or system management solution, being a single-wire bus implementing a substantially simple protocol, while minimizing required digital circuitry within the sensor circuit (or any other selected monitored circuit) and also minimizing any additional burden on the host device. In one set of embodiments, the BBUS operates as a low speed, reliable management bus that is low cost due to both its implementation and single pin design.

### BRIEF DESCRIPTION OF THE DRAWINGS

The foregoing, as well as other objects, features, and advantages of this invention may be more completely understood by reference to the following detailed description when read together with the accompanying drawings in which:

FIG. 1 illustrates one embodiment of a thermal management system that utilizes the Budget Sensor Bus (BBUS);

FIG. 2 illustrates a packet format for one embodiment of the BBUS single-wire bus protocol;

FIG. 3 is a table containing temperature data format examples for one embodiment of the BBUS;

FIG. 4 is a table containing voltage data formats for one embodiment of the BBUS;

FIG. 5 illustrates one embodiment of the physical layer implementation of the BBUS;

FIG. 6 is a data-bus timing diagram for one embodiment of the BBUS;

FIG. 7 is a timing diagram illustrating inactive time between packets and power down timing for one embodiment of the BBUS;

FIG. 8 is a table containing bus timing information for one embodiment of the BBUS;

FIG. 9 is a table containing electrical characteristics for one embodiment of the BBUS;

FIG. 10 illustrates a packet format for one alternate embodiment of the BBUS single-wire bus protocol; and

FIG. 11 is a table containing general, system, or user defined data format examples for one embodiment of the BBUS.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Note, the headings are for organizational purposes only and are not meant to be used to limit or interpret the description or claims. Furthermore, note that the word “may” is used throughout this application in a permissive sense (i.e., having the potential to, being able to), not a mandatory sense (i.e., must).” The term “include”, and derivations thereof, mean “including, but not limited to”. The term “coupled” means “directly or indirectly connected”.

### DETAILED DESCRIPTION OF THE PREFERRED EMBODIMENTS.

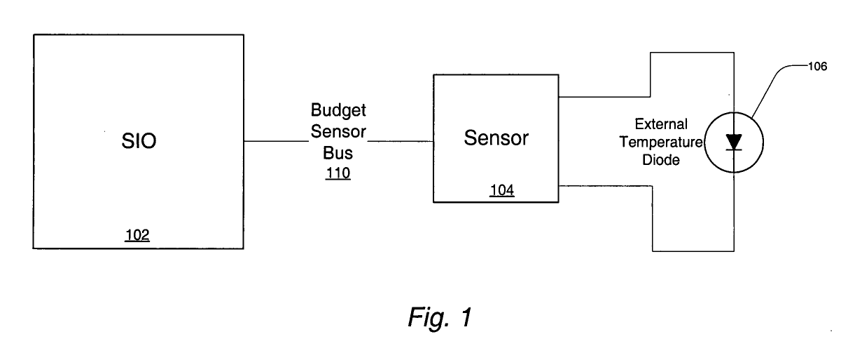

FIG. 1 illustrates one embodiment of a thermal management system that utilizes the Budget Sensor Bus (BBUS). A sensor circuit 104 may be coupled to Super I/O (SIO) controller device 102 via BBUS 110. In the embodiment of FIG. 1, sensor circuit 104 is used to obtain temperature measurements using external temperature diode 106 coupled to sensor circuit 104. In alternate embodiments, sensor circuit 104 may be used to obtain voltage measurements. Those skilled in the art will appreciate that other system characteristics besides temperature and/or voltage may also be measured, and that sensor circuit 104 may be configured accordingly to obtain the data corresponding to these system characteristics. In one set of embodiments, BBUS 110 comprises a single-wire bus protocol configured to transmit packets of information in Non-Return to Zero (NRZ) format. NRZ encoding may be used to represent the binary bit-value ‘1’ by a positive or higher voltage, and the binary bit-value ‘0’ by a low or negative voltage, and may be employed for both synchronous and asynchronous transmission.

In addition to the single-wire interface, BBUS 110 may additionally feature point-to-point data transmission, 3.3 Volt signaling, and an operating frequency of 100 KHz±20%. In one embodiment, BBUS 110 supports up to eight sensors, and employs a data format that supports measured temperature ranges of −63.875° C. to 191.875° C. The up to eight sensors of each type (temperature and voltage) supported by BBUS 110 may be configured in a single sensor block or sensor Integrated Circuit (IC) to support the single-wire interface. BBUS 110 may also allow the sensors that are coupled to BBUS 110 to be placed in a low power mode. In one set of embodiments the BBUS protocol features three main states: Reset (or Power Down State), Active State, and Inactive State.

The Power Down state may be used by SIO controller device 102 to place sensor circuit 104 in a low power state or to put sensor circuit 104 on hold when SIO controller device 102 cannot accept more data. The Power Down state may be initiated by SIO controller device 102 by driving and holding a low state on the bus. SIO controller device 102 may also force the bus into the Power Down state if the bus is in the Inactive state. Sensor circuit 104 may be responsible for detecting the Power Down state when sensor circuit 104 is the Inactive state. SIO controller device 102 may be required to drive the bus high for one clock cycle (which may be of a 100 kHz±20% frequency) before releasing the bus when exiting the Power Down state.

The Inactive state may be designated the default bus state when no data is being transferred. In one embodiment, the Inactive state is characterized by the bus not being driven by either sensor circuit 104 or SIO controller device 102. An internal weak pull-up resistor may be configured on SIO controller device 102 to hold the bus in a high state.

The Active state may be used by sensor circuit 104 to transmit sensor data. In this state the sensor may transmit nineteen bits of data to SIO control device 102 and then return the bus to the Inactive state. Sensor circuit 104 may enter the Active State sixteen clock cycles (which may be of a 100 kHz±20% frequency) after the bus enters the Inactive state. When the bus is in the Inactive state, both sensor circuit 104 and SIO controller device 102 may be required to have their output drivers in a high impedance state.

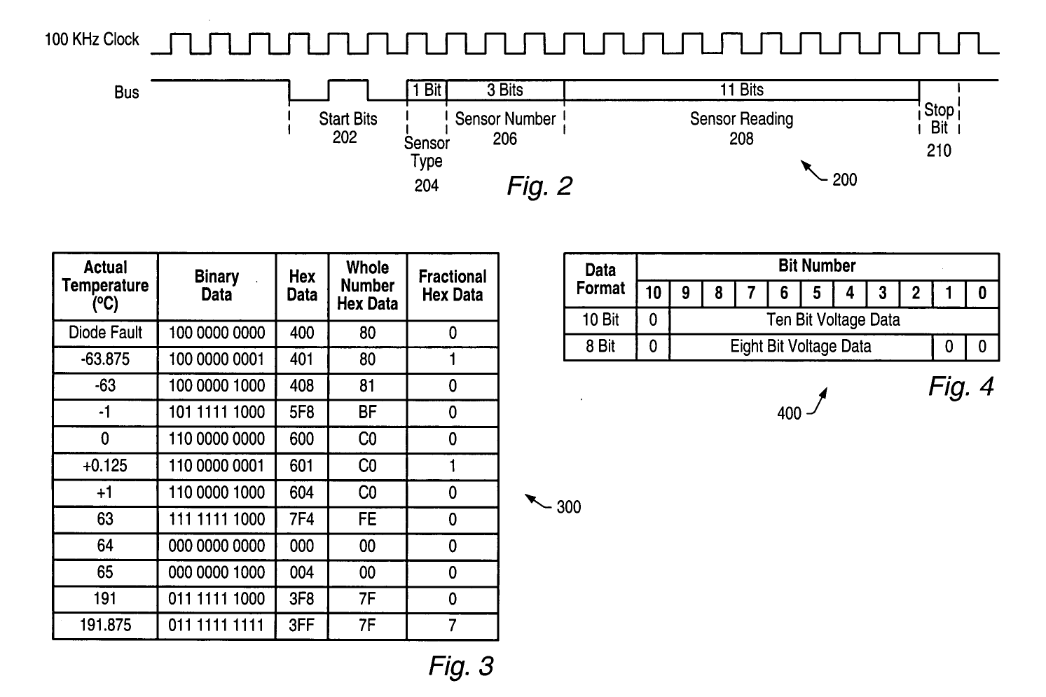

As previously mentioned, BBUS 110 may transmit packets of information. FIG. 2 illustrates the packet format for one embodiment of the BBUS single-wire bus protocol. Packets may be transmitted in NRZ format with each packet comprising a three-bit start sequence 202, one sensor-type bit 204, a three-bit sensor number 206, eleven-bit sensor data 208 and one stop bit 210. Start sequence 202 may be used by SIO controller device 102 to determine where to sample the sensor data. In one embodiment, start sequence 202 comprises the binary bit-sequence ‘010’. Sensor-type bit 204 may be used to indicate whether data being transferred is temperature data or voltage data. In one embodiment, sensor number 206 indicates which sensor—of eight possible sensors—is associated with sensor data 208. Sensor number 206 and sensor data 208 may both be transmitted Most Significant Bit (MSB) first. Sensor circuit 104 may be required to drive the bus high for one clock cycle (which may be of a 100 kHz±20% frequency) before releasing the bus after sending the last data bit. Stop bit 210 may indicate the end of transmission for a packet.

In one embodiment, temperature data (sensor data 208 when sensor type bit 204 is set to indicate temperature data) is transmitted in two's complement form with a decimal offset of 64. Bits 10-3 of sensor data 208 may represent the whole number portion of the temperature value while bits 2-0 of sensor data 208 may represent the fractional portion of the temperature value. An actual temperature reading may be determined by adding 64 to the whole number portion of the temperature measurement. FIG. 3 shows a table containing examples of the temperature data format according to one set of embodiments. In the table of FIG. 3 the hexadecimal value ‘400’ is reserved for a diode fault.

Voltage data (sensor data 208 when sensor type bit 204 is set to indicate voltage data) may be transmitted in 10-bit or 8-bit binary form with bit 10 being a reserved bit. In 8-bit binary format, bits ‘0’ and ‘1’ may be set to zero. In one set of embodiments where sensor circuit 104 comprises an analog to digital converter (ADC), the actual measured voltage value may be determined by the following formula:
V_{Measurement}=(V_{ref}*Sensor Reading)/1024 (1)
where V_{ref} is the reference voltage used by the ADC, and the Sensor Reading represents the decimal equivalent of the binary data transmitted sensor circuit 104. The table of FIG. 4 illustrates the voltage data format for both the 10-bit and 8-bit configurations, with bit 10 being the MSB and bit 0 being the Least Significant Bit (LSB). While in the embodiments discussed above, sensor type bit 204 is set to a binary value of ‘0’ to indicate temperature value, and set to a binary value of ‘1’ to indicate voltage value, in alternate embodiments these values may be switched, and a binary value of ‘1’ may denote temperature value, and a binary value of ‘0’ may denote a voltage value.

In one set of embodiments, sensor circuit 104 may be required to restart conversions beginning with sensor number 206 set to 000, that is, from designated sensor number zero, upon exiting the Power Down state. Sensor circuit 104 may also be required to transmit temperature conversion/voltage data to SIO controller device 102 over BBUS 110 in sensor number order. In one embodiment, sensor circuit 104 assigns sensor numbers to all enabled sensors sequentially starting from zero and without skipping any numbers. For example, if sensor circuit 104 contains five enabled sensors, the five sensors may receive sensor numbers zero through four.

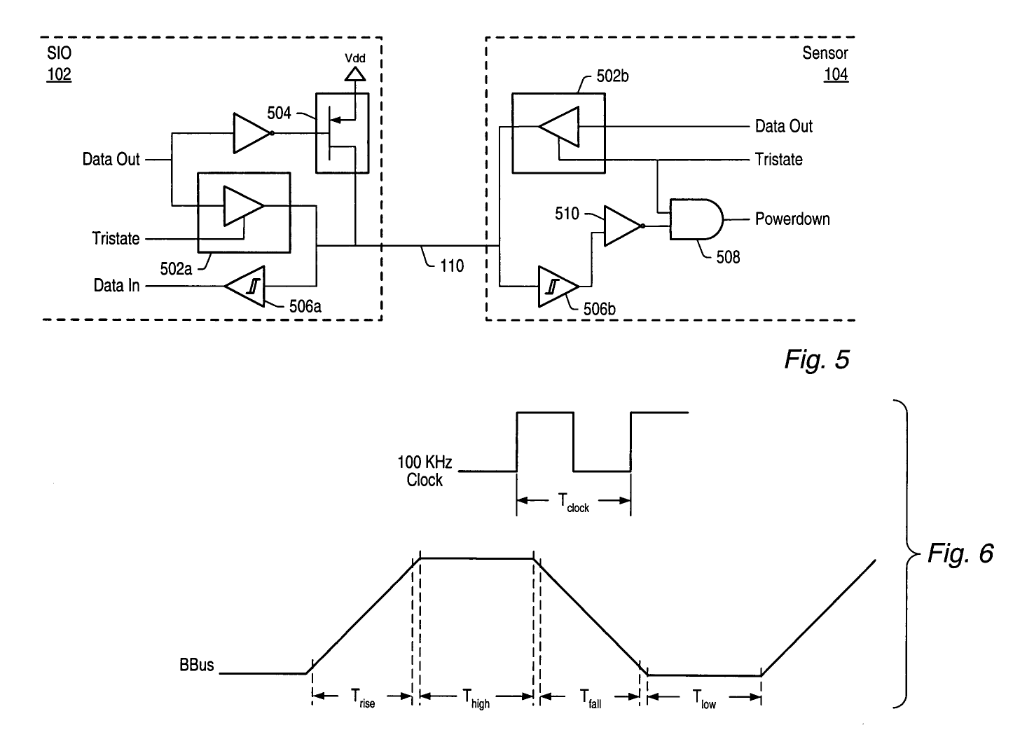

In order to reduce the risk of bus contention, in one set of embodiments SIO controller device 102 may be required to initiate the Power Down state during a required inactive time between packets, or place BBUS 110 in a low state using an integrated, weak pull-down resistor. In order to reduce power, SIO controller device 102 may also integrate a pull-up resistor that may be used on BBUS 110, and disable the pull-up resistor when placing a sensor in Power Down mode. SIO controller device 102 may also be required to implement a Schmitt trigger input as an input cell on BBUS 110. FIG. 5 illustrates one embodiment of such physical layer implementation of the BBUS. Sensor circuit 104 and SIO controller device 102 may each use a tri-state pad cell, shown as pad cells 502a and 502b, respectively, to meet the electrical requirements of BBUS 110. Pad cells 502a and 502b may include push-pull and tri-stating capabilities that may be used by both SIO controller device 102 and sensor circuit 104. For buffering data, SIO controller device 102 and sensor circuit 104 may be configured with Schmitt trigger input cells 506a and 506b, respectively. In one embodiment, SIO controller device 102 additionally implements a pull-up cell 504 attached to BBUS 110. Pull-up cell 504 may be disabled when SIO controller device 102 pulls down the bus (DATA_OUT=0), effectively reducing current consumption on BBUS 110 to substantially zero.

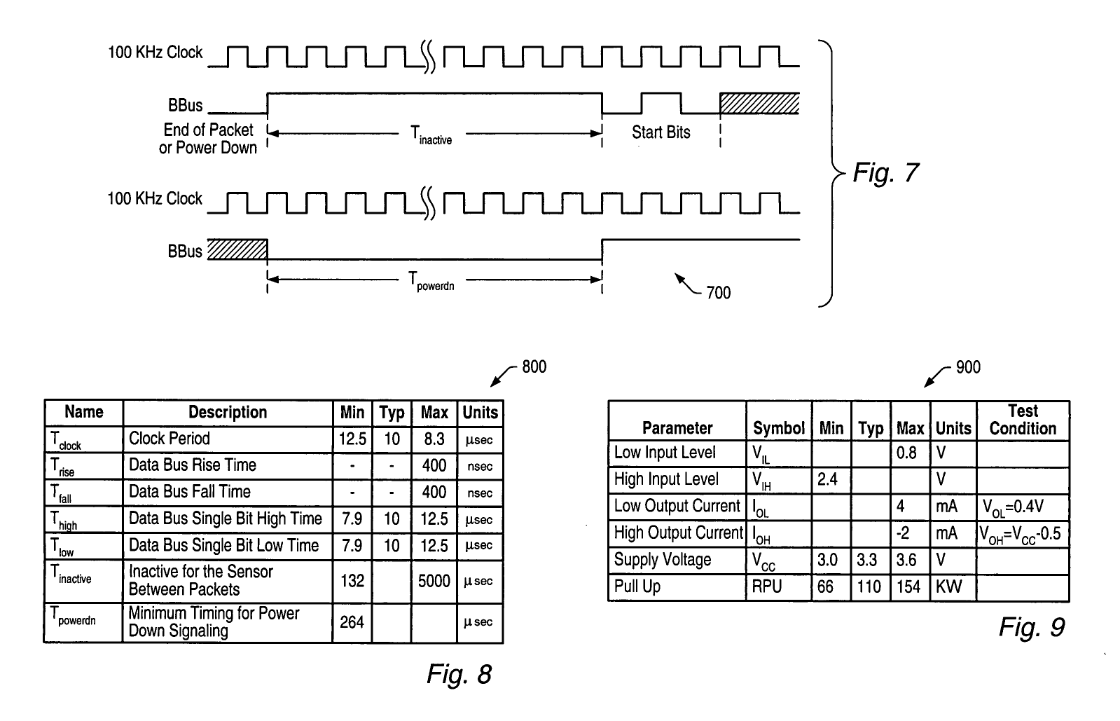

FIG. 6 illustrates data-bus timing for one embodiment of BBUS 110, FIG. 7 illustrates inactive time between packets and power down timing for one embodiment of BBUS 110, and FIG. 8 shows a table containing bus timing information for the timings shown in FIG. 6 and FIG. 7. For the embodiment illustrated in FIGS. 6-8, all timings are measured with respect to the clock of the transmitting device. Any receiving devices may have to account for the variance allowed by the clock specification. SIO controller device 102 may be allowed to drive BBUS 110 low during inactive time T_{inactive}. In one set of embodiments, T_{inactive} may be equivalent to 16 clock cycles at 120 kHz, which may be designated as a maximum operating frequency of BBUS 110. The Power Down duration T_{powerdn} may be equivalent to 32 clock cycles at 120 kHz, which may again be designated as a maximum operating frequency of BBUS 110. FIG. 9 shows a table containing electrical characteristics for one embodiment of BBUS 110, as related to the physical layer embodiment shown in FIG. 5. In one embodiment, a fail-safe buffer is coupled to BBUS 110 to prevent BBUS 110 from being forced in a low state when power is removed from sensor circuit 104.

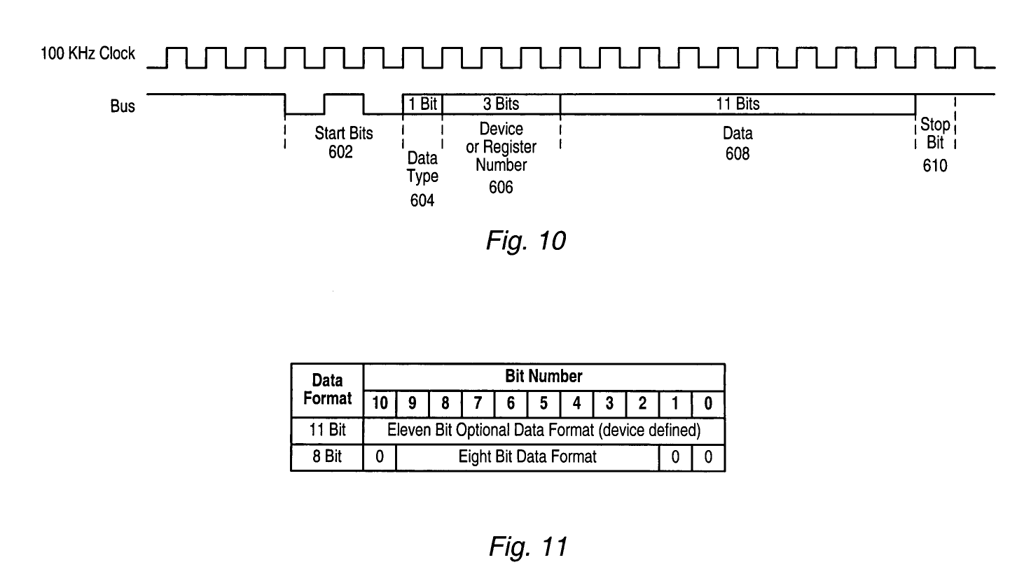

While the packets above are described for sensor circuit 104, as previously indicated, instead of sensor circuit 104 alternate devices and/or circuits may be monitored through BBUS 110, such as an embedded processor or CPU, with BBUS 110 coupling the alternate device to various system logic, for example a Southbridge in lieu of SIO controller device 102. FIG. 10 illustrates a packet format for one alternate embodiment of BBUS 110. In this embodiment each packet comprises a start sequence 602, a data type 604, a device or register number 606, device data 608, and a stop sequence 610. Those skilled in the art will appreciate that while each portion of the packet is shown as comprising a specific number bits, any of those portions may comprise any number of previously selected bits based on particular system requirements for which BBUS may be adapted. Examples of data types may include system status, configuration or management data such as CPU type and/or ID, memory size or type, docking type or ID, information about the presence of optional components and ambient light or noise levels. Other data types while not explicitly mentioned may also be contemplated. Relating to FIG. 10, FIG. 11 is a table containing general, system, or user defined data format examples for one embodiment of the BBUS. An 11-bit and an 8-bit data format are presented, with bit 11 being the MSB and bit 0 being the LSB.

Although the embodiments above have been described in considerable detail, other versions are possible. Numerous variations and modifications will become apparent to those skilled in the art once the above disclosure is fully appreciated. It is intended that the following claims be interpreted to embrace all such variations and modifications. Note the section headings used herein are for organizational purposes only and are not meant to limit the description provided herein or the claims attached hereto.

We claim:

1. A system, comprising:
a unidirectional point-to-point single-wire bus;
a host device coupled to a first end of the bus; and
a monitored circuit coupled to a second end of the bus, wherein the monitored circuit comprises one or more monitored devices, and is operable to transmit information packets to the host device over the bus, wherein each one of the information packets comprises:
a start sequence identifier;
a data type identifier;
a device number identifier;
device information data; and
a stop sequence identifier;
wherein the host device is operable to use the start sequence identifier to determine where to begin sampling information contained in a corresponding packet;
wherein the host device is operable to receive and process the device information data;
wherein the host device is operable to use the device number identifier to determine to which one of the one or more monitored devices the device information data corresponds;
wherein the host device is operable to use the data type identifier to determine what type of data the device information data is;
wherein the monitored circuit is operable to use the stop sequence identifier to drive the bus high; and
wherein information packets are transmitted from the monitored circuit to the host device but not from the host device to the monitored circuit.

2. The system of claim 1;
wherein the monitored circuit is a sensor circuit;
wherein the data type identifier is a sensor type identifier;
wherein the device number identifier is a sensor number identifier; and
wherein the device information data is sensor data; and
wherein the sensor type identifier indicates whether the sensor data is temperature data or voltage data.

3. The system of claim 2, wherein the sensor circuit comprises up to eight temperature sensing devices each operable to provide temperature data as the sensor data indicative of a corresponding measured temperature value, and up to eight voltage sensing devices each operable to provide voltage data as the sensor data indicative of a corresponding measured voltage value.

4. The system of claim 3, wherein the temperature data is in two's complement form with a decimal offset.

5. The system of claim 4;
wherein the decimal offset is 64;
wherein bits 10-3 of the temperature data represent a whole number portion of the measured temperature value; and
wherein bits 2-0 of the temperature data represent a fractional portion of the measured temperature value.

6. The system of claim 5, wherein an actual temperature reading is determined by adding 64 to the whole number portion of the measured temperature value.

7. The system of claim 3, wherein the voltage data is in one of:
a ten bit binary form; and
an eight bit binary form;
wherein bit 10 is a reserved bit.

8. The system of claim 7, wherein in the eight bit binary format bits 0 and 1 are always zero.

9. The system of claim 7, wherein the measured voltage value is determined by a relationship expressed as:
Vₘ=(V_{ref}*V_{data})/1024;
wherein V_{ref} is a reference voltage value of an ADC comprised in the sensor circuit, Vₘ is the measured voltage value, and Vdata is a decimal equivalent of the voltage data.

10. The system of claim 3, wherein the sensor circuit is configured to restart transmitting information packets from a sensing device indicated by the sensor number identifier as sensing device number zero.

11. The system of claim 3, wherein the sensor circuit is configured to transmit information packets in sensing device number order.

12. The system of claim 3, wherein the sensor circuit is configured to assign numbers to all enabled sensing devices sequentially, starting from zero without skipping any numbers.

13. The system of claim 3 configured to enable low cost temperature sensing devices and low cost voltage sensing devices.

14. The system of claim 1 configured to allow the monitored circuit to be placed in a low power mode.

15. The system of claim 1, wherein the bus operates at 3.3 Volt signaling levels.

16. The system of claim 1, wherein the bus supports temperature ranges of −63.875° C. to 191.875° C.

17. The system of claim 1, wherein the bus is configured for an operating frequency of 100 KHz±20%.

18. The system of claim 1;
wherein the bus is configured to operate in one of:
a power down state;
an inactive state; and
an active state.

19. The system of claim 18, wherein the host device is operable to force the bus into the power down state if the bus is in the inactive state.

20. The system of claim 18, wherein the monitored circuit is configured to detect the power down state when the monitored circuit is in the inactive state.

21. The system of claim 18, wherein the host device is configured to drive the bus high for one clock cycle before releasing the bus when exiting the power down state.

22. The system of claim 18, wherein the inactive state is the default state for the bus when no information packets are transmitted.

23. The system of claim 18, wherein the host device and the monitored circuit are configured to not drive the bus when the bus is in the inactive state.

24. The system of claim 18, wherein the host device is configured with an internal weak pull-up resistor, which is operable to hold the bus high.

25. The system of claim 18, wherein the sensor circuit is configured to transmit information packets when the bus is in the active state.

26. The system of claim 25, wherein the monitored circuit is configured to return the bus to the inactive state upon having transmitted an information packet to the host device.

27. The system of claim 26, wherein the monitored circuit is operable to enter the active state a first determined number of clock cycles after the bus has entered the inactive state.

28. The system of claim 27, wherein the host device is configured to initiate the power down state during the first determined number of clock cycles.

29. The system of claim 27, wherein the host device is configured to pull the bus low during the first determined number of clock cycles.

30. The system of claim 27, wherein the first determined number of clock cycles is 16.

31. The system of claim 18, wherein the monitored circuit and the host device are configured to have their output drivers in a high impedance state when the bus is in the inactive state.

32. The system of claim 1, wherein the information packets are transmitted in NRZ format.

33. The system of claim 1, wherein the start sequence identifier comprises three bits.

34. The system of claim 1, wherein the data type identifier comprises one bit.

35. The system of claim 1, wherein the device number identifier comprises three bits.

36. The system of claim 1, wherein the device information data comprises eleven bits.

37. The system of claim 1, wherein the stop sequence identifier comprises one bit.

38. The system of claim 1, wherein the monitored circuit is configured to transmit the device number identifier and the sensor data MSB first.

39. The system of claim 1, wherein the monitored circuit is configured to drive the bus high for one clock cycle before releasing the bus after having sent a last bit of an information packet.

40. The system of claim 1, wherein the host device is one of:
an SIO device; and
a Southbridge.

41. The system of claim 1, wherein the device information data comprises one or more of:
system status information;
system configuration information; and
system management information.

42. The system of claim 41, wherein the system status information, the system configuration information, and the system management information comprise one or more of:
information about the presence of optional system components;
ambient light information;
noise level information;
CPU type information;
CPU identification information;
memory size and/or type; and
docking type and/or identification.

43. The system of claim 1, wherein the monitored circuit is one of:
an embedded processor; and
a CPU.

44. The system of claim 1, wherein each packet is of a same fixed length.

45. A method for conveying information from a monitored circuit comprising one or more monitored devices to a host device, the method comprising:
the monitored circuit transmitting information packets to the host device over a unidirectional point-to-point single-wire bus, wherein the monitored circuit and the host device are each coupled to opposite ends of the bus, wherein each one of the information packets comprises:
a start sequence identifier;
a data type identifier;
a device number identifier;
device information data; and
a stop sequence identifier;
the host device determining where to begin sampling information contained in a corresponding packet, using the start sequence identifier;
the host device receiving the device information data;
the host device determining to which one of the one or more monitored devices the device information data corresponds based on the device number identifier;
the host device identifying what type of data the device information data is based on the data type identifier; and
the monitored circuit driving the bus high using the stop sequence identifier;
wherein information packets are transmitted from the monitored circuit to the host device but not from the host device to the monitored circuit.

46. The method of claim 45, further comprising:
the host device processing the device information data.

47. A carrier medium for carrying information packets from a monitored circuit to a host device;
wherein the monitored circuit comprises one or more monitored devices;
wherein each one of the information packets comprises:
a start sequence identifier;
a data type identifier;
a device number identifier;
device information data; and
a stop sequence identifier;
wherein the host device is operable to use the start sequence identifier to determine where to begin sampling information contained in a corresponding packet;
wherein the host device is operable to use the device number identifier to determine to which one of the one or more monitored devices the device information data corresponds;
wherein the host device is operable to use the data type identifier to determine what type of data the device information data is;
wherein the monitored circuit is operable to use the stop sequence identifier to drive the bus high; and
wherein information packets are transmitted over a single channel of the carrier medium from the monitored circuit to the host device but not from the host device to the monitored circuit.
